(19) United States
(12) Patent Application Publication
(10) Pub. No.: US 2021/0081938 A1
(43) Pub. Date: Mar. 18, 2021

(54) METHOD AND APPARATUS FOR COMPUTER-ASSISTED PROVISION OF A SECURITY-PROTECTED DIGITAL TWIN

(71) Applicant: Siemens Aktiengesellschaft, München (DE)

(72) Inventor: Rainer Falk, Poing (DE)

(21) Appl. No.: 16/497,964

(22) PCT Filed: Sep. 26, 2017
(86) PCT No.: PCT/EP2017/074396

§ 371 Date: Sep. 26, 2019

(30) Foreign Application Priority Data
Mar. 31, 2017 (EP) 17164205.1

(51) Int. Cl. G06Q 20/38; H04L 9/32

(52) U.S. Cl. CPC G06Q 20/38215; G06Q 20/3825; H04L 2209/56; H04L 9/3247; H04L 2209/38; H04L 9/3236

(57) ABSTRACT

Provided is a method for computer-assisted creation of a security-protected digital twin, including the following method steps providing at least one selected subset of data of a primary digital twin; storing transactions, wherein the transactions comprise the selected subset of the data and/or first checksums for the selected subset of the data are calculated and the transactions comprise the first checksum; creating the security-protected digital twin by generating links of a block chain, wherein the links comprise the transactions and the links are joined to one another to form the block chain.

### CROSS-REFERENCE TO RELATED APPLICATIONS

This application claims priority to PCT Application No. PCT/EP2017/074396, having a filing date of Sep. 26, 2017, which is based off of EP Application No. 17164205.1, having a filing date of Mar. 31, 2017, the entire contents both of which are hereby incorporated by reference.

### FIELD OF TECHNOLOGY

The following relates to a method and an apparatus for computer-assisted provision of a security-protected digital twin.

### BACKGROUND

Block chain or “distributed ledger” technology is a technology currently under intense discussions. In addition to applications for decentralized payment systems (e.g., bitcoin), new application options are being developed in the financial industry. In particular, transactions between companies can be realized without brokers or clearinghouses in tamper-proof fashion as a result thereof. This opens up new business models without a trustworthy broker, reduces the transaction costs and allows flexible offers of new digital services without needing to set up specifically configured infrastructure and trust relationships to this end. A transaction data record (transaction for short) that is protected by a blockchain comprises, e.g., program code, which can also be referred to as a so-called “smart contract”.

### SUMMARY

An aspect relates to provide a method and an apparatus for computer-assisted provision of a security-protected digital twin.

According to a first aspect, embodiments of the invention relates to a method for computer-assisted creation of a security-protected digital twin, including the following method steps:
Providing a selected portion of data of a primary digital twin;
storing transactions, wherein
   the transactions comprise the selected portion of the data and/or
   first checksums are calculated for the selected portion of the data and the transactions comprise the first checksums;
creating the security-protected digital twin by producing blocks of a blockchain or of a distributed database, wherein
   the blocks comprise the transactions;
   the blocks are linked together to form the blockchain or the distributed database.

Provided the following description specifies nothing else, terms such as “carrying out”, “calculating”, “computer-assisted”, “computing”, “determining”, “generating”, “configuring”, “reconstructing” and the like relate to actions and/or processes and/or processing steps that modify and/or produce data and/or convert the data into other data, wherein the data, in particular, can be represented as physical variables or can be present, for example as electrical pulses. In particular, the expression “computer” should be interpreted as broadly as possible in order, in particular, to cover all electronic devices with data processing properties. Consequently, computers could be, e.g., personal computers, servers, programmable logic controllers (PLCs), handheld computer systems, Pocket PC devices, mobile radio devices and other communication devices that can process data in computer-assisted fashion, processors and other electronic devices for data processing.

In conjunction with embodiments of the invention, “computer-assisted” can be understood to mean, for example, an implementation of the method in which, in particular, a processor executes at least one method step of the method.

In conjunction with embodiments of the invention, a processor can be understood to mean, for example, a machine or an electronic circuit. In particular, a processor can be a central processing unit (CPU), a micro-processor or a microcontroller, for example an application-specific integrated circuit or a digital signal processor, possibly in combination with a memory unit for storing program commands, etc. By way of example, a processor may also be an IC (integrated circuit), more particularly an FPGA (field programmable gate array) or an ASIC (application-specific integrated circuit), or a DSP (digital signal processor) or a GPU (graphic processing unit). A processor can also be understood to mean a virtualized processor, a virtual machine or a soft CPU. By way of example, this may also relate to a programmable processor that is equipped with configuration steps for executing the specified method according to embodiments of the invention or that is configured by means of configuration steps in such a way that the programmable processor realizes the inventive features of the method, of the component, of the modules, or of other aspects and/or partial aspects of embodiments of the invention.

In conjunction with embodiments of the invention, a “memory unit” or “memory module” and the like can be understood to mean, for example, a volatile memory in the form of random-access memory (RAM) or a permanent memory such as a hard disk drive or a data medium.

In conjunction with embodiments of the invention, a “module” can be understood to mean, for example, a processor and/or a memory unit for storing program commands. By way of example, the processor is specifically configured to execute the program commands in such a way that the processor carries out functions in order to implement or realize the method according to the invention or a step of the method according to the invention.

In conjunction with embodiments of the invention, “provision” can be understood to mean, for example, loading or storing, for example the primary digital twin, from or to a memory module. By way of example, “provision” can also be understood to mean transferring (or transmitting) the corresponding data to a receiver, e.g., a blockchain node or a node of a distributed database.

In conjunction with embodiments of the invention, “security-protected” can be understood to mean, for example, protection that is realized by a cryptographic method, in particular. By way of example, this can be achieved by using the blockchain for the provision or transmission or transfer of the corresponding data. This is achieved by a combination of the various (cryptographic) checksums by virtue of these interacting, more particularly in synergetic fashion, in order to improve the security or the cryptographic security of the corresponding data, for example. Expressed differently, “security protected” in conjunction with embodiments of the invention can also be understood to mean, in particular, “cryptographically protected” and/or “protected from tampering”.

In conjunction with embodiments of the invention, a “distributed database” can be understood to mean, for example, a decentralized distributed database, a blockchain or a peer-to-peer database. By way of example, if a blockchain is used, the latter can be implemented, in particular, by means of a bitcoin-based realization or an Ethereum-based realization. In conjunction with embodiments of the invention, a “distributed database” can also be understood to mean, for example, distributed or decentralized distributed databases without a distributed database in the form of a blockchain. In particular, this should be understood to mean that, in this case, the blockchain, for example, might not be comprised in possible specific implementation variants of distributed databases by way of this disclaimer. Otherwise, the exemplary embodiments and embodiments directed to a blockchain, in particular, can likewise be transferred to a distributed database. In particular, the definitions made for a blockchain likewise apply to a distributed database —provided this is meaningful.

In conjunction with embodiments of the invention, a “checksum”, for example the first checksum, a second checksum, a node checksum, a transaction checksum or a link checksum, can be understood to mean, for example, a cryptographic checksum or cryptographic hash or hash value, which, in particular, are formed or calculated by means of a cryptographic hash function over a data record and/or data and/or one of the transactions and/or a block header. In particular, a checksum can be (a) checksum(s) or (a) hash value(s) of a hash tree (e.g., Merkle tree, Patricia tree). Furthermore, this can also be understood to mean, in particular, a digital signature or a cryptographic message authentication code.

In conjunction with embodiments of the invention, a “first checksum” can be understood to mean a checksum that, for example, is calculated over the data (records) of a transaction. Instead of the data, e.g., the selected portion of the data, a transaction may comprise only the checksum—more precisely the corresponding associated first checksum—for these data, for example. By way of example, the corresponding data can then be provided in a further transaction of a further block. However, for example, it is also conceivable that these data are provided over a different communications channel. By way of example, a node can then check the integrity/authenticity of the data by means of the first checksum from the blockchain. By way of example, an additional data record may also be in the transactions in addition to the first checksum, said additional data record, in particular, specifying a storage location from where the data can be downloaded. In particular, this is advantageous in respect of keeping the data size of the blockchain as small as possible. Additionally, a calculation of a transaction checksum, for example, can be accelerated since checksums are already present in this case and these can directly be used as leaves, for example of a Merkle tree. Here, it is possible in particular to dispense with forming a separate checksum over the additional data record.

In conjunction with embodiments of the invention, a “transaction checksum” can be understood to mean a checksum that, in particular, is formed over the respective transactions of one of the respective blocks and/or a preceding block/previous block of a block of the blockchain. In addition or as an alternative thereto, the transaction checksum may have also been formed, in particular, over transactions of a preceding block/previous block of the block. Here, in particular, the transaction checksum may also be realized by means of a hash tree, for example a Merkle tree [1] or a Patricia tree, wherein the transaction checksum is, in particular, the root checksum of the Merkle tree or of a Patricia tree or of a binary hash tree. In particular, transactions are secured by means of further checksums of the Merkle tree or Patricia tree, wherein, in particular, the further checksums are leaves in the Merkle tree or Patricia tree. By way of example, the transaction checksum can consequently secure the transactions by virtue of forming the root checksum from the further checksums. In particular, the transaction checksum can be calculated for transactions of a first block of the blocks. In particular, such a transaction checksum can be included in a subsequent block of the first block in order to link this subsequent block, for example to its preceding blocks (e.g., the first block) and, in particular, in order to render an integrity of the blockchain checkable thereby.

In conjunction with embodiments of the invention, a “link checksum” can be understood to mean a checksum that, in particular, specifies or references the preceding block of the blockchain for a respective block of the blockchain (in the art, this is often referred to as “previous block hash”, in particular)[1]. By way of example, the transaction checksum of a block can serve as link checksum in order to link a new block to a block of the blockchain. By way of example, it is also possible, however, that a checksum is formed over a header of the preceding block or over the entire preceding block and this is used as the link checksum. A respective block of the blockchain comprises a link checksum in each case, said link checksum having been calculated for a preceding block of the respective block.

In conjunction with embodiments of the invention, “linking the blocks/linking blocks of a blockchain” can be understood to mean that, for example, blocks each comprise information (e.g., a link checksum) that refers to another block or a plurality of other blocks of the blockchain, or references these [1].

In conjunction with embodiments of the invention, “inserting into the blockchain” and the like can be understood to mean that, for example, a transaction or the transactions or a block with its transactions, in particular, is transmitted to one or more nodes of a blockchain. By way of example, if these transactions are successfully validated (e.g., by the node/nodes), these transactions are linked, in particular, as (a) new block(s) with at least one block present in the blockchain [1]. In particular, this validation and/or linking can be implemented by a trustworthy node (e.g., a mining node or blockchain platform). In particular, in this case, a blockchain platform can be understood to mean a blockchain as a service, as proposed by Microsoft or IBM, in particular. In particular, a trustworthy node and/or a node can each store a node checksum (e.g., a digital signature) in a block in order, in particular, to facilitate identifiability of the creator of the block and/or in order to facilitate identifiability of the node. Here, this node checksum specifies which node, for example, has linked the corresponding block to at least one other block of the blockchain.

In conjunction with embodiments of the invention, “transaction” or “transactions” can be understood to mean, for example, a smart contract, a data structure or a transaction data record which, in particular, respectively comprises one of the transactions or a plurality of transactions. In conjunction with embodiments of the invention, “transaction” or “transactions” can also be understood to mean, for example, the data of a transaction of a block of a blockchain. A transaction data record or transaction may comprise program code that, in particular, realizes a smart contract. In conjunction with embodiments of the invention, a “transaction data record” could also be understood to mean, for example, a transaction of a block of a blockchain.

In conjunction with embodiments of the invention, “program code” can be understood to mean, for example, control commands, program commands or control instructions that, in particular, are stored in a transaction.

In conjunction with embodiments of the invention, a “smart contract” can be understood to mean, for example, executable program code. In particular, the program code is executable on a virtual machine.

In conjunction with embodiments of the invention, “storing transactions” can be understood to mean, for example, storing data (e.g., of the selected portion of the data, etc.) in a transaction or in a transaction data record. By way of example, it is also conceivable that it is not the data that are stored directly but that only a checksum (e.g., the first checksum) of the corresponding data is stored in the transaction.

In conjunction with embodiments of the invention, “proof-of-work evidence” can be understood to mean, for example, a solution to a computation-intensive problem which, in particular, should be solved as a function of the block content/content of a first transaction data record [1]. By way of example, such a computation-intensive problem is also referred to as cryptographic puzzle, for example.

In conjunction with embodiments of the invention, a “block” can be understood to mean, for example, a block of a blockchain which, in particular, is realized as a data structure and which comprises one of the transactions or a plurality of the transactions in each case. By way of example, a block may comprise specifications in respect of the size (data size in bytes) of the block, a block header, a transaction counter and one or more transactions [1]. By way of example, the block header may comprise a version, a link checksum, a transaction checksum, a timestamp, proof-of-work evidence and a nonce (single value, random value or counter that is used for the proof-of-work evidence) [1].

In conjunction with embodiments of the invention, a “nonce” can be understood to mean, for example, a cryptographic nonce (abbreviation for: “used only once” [2] or “number used once” [3]). In particular, a nonce denotes an individual number or letter combination which is used a single time in the respective context (e.g., transaction, data transfer).

In conjunction with embodiments of the invention, “preceding blocks of a (first) block of the blockchain” can be understood to mean, for example, only the block of the blockchain that, in particular, precedes a (first) block directly. Alternatively, “preceding blocks of a (first) block of the blockchain” can also be understood to mean, in particular, all blocks of the blockchain preceding the first block. As a result, the link checksum or the transaction checksum, for example, can be formed, in particular, only over the block (or the transactions thereof) directly preceding the first block or over all blocks (or the transactions thereof) preceding the first block.

In conjunction with embodiments of the invention, a “blockchain node”, “node”, “node of a blockchain” and the like can be understood to mean, for example, devices (e.g., field devices), computers, smart phones, clients or peers that perform operations with a blockchain [1]. By way of example, such nodes can execute transactions of a blockchain or the blocks thereof or can insert or link new blocks with new transactions into the blockchain by means of new blocks. In particular, this validation and/or linking can be implemented by a trustworthy node (e.g., a mining node) or can be implemented exclusively by trustworthy modes. By way of example, a trustworthy node, is a node that comprises additional security measures (e.g., firewalls, access restrictions to the node, or the like) for preventing tampering with the node. As an alternative or in addition thereto, a trustworthy node, for example, can store a second checksum (e.g., a digital signature or certificate) in the new block when linking a new block with the blockchain. Then, it is possible, in particular, to provide evidence that specifies that the block was inserted by a certain node or that specifies the origin of said node.

In conjunction with embodiments of the invention, a “computer” can be understood to mean, for example, a computer (system), a client, a smart phone, a device or a server that is respectively arranged outside of the blockchain or is no peer of the blockchain (i.e., does not carry out any operations with the blockchain or only queries the latter without, however, carrying out transactions, inserting blocks or calculating proof-of-work evidence). Alternatively, a computer can also be understood to mean, in particular, a node of a blockchain.

In conjunction with embodiments of the invention, a “digital twin” can be understood to mean, for example, a digital mapping, in particular in the form of a data model or data structure, of a real product, of a (technical) article or of a (physical) object. By way of example, these are (electrical/electromechanical/electronic) devices, wind turbines or large installations such as offshore platforms. In particular, the term digital twin is also explained in the following patent applications: WO2016/141998 or PCT/EP2016/064785. In particular, a digital twin can be updated on the basis of data of the mapped article. These corresponding data can be captured by sensors, for example, and can then update the digital twin. By way of example, this can be implemented in real-time, periodically, under manual control or at predetermined times. By way of example, a primary digital twin can be understood to mean a very detailed digital mapping of an article that, in particular, comprises a large amount of data and, for example, comprises hundreds or thousands of data records. In particular, a digital twin may comprise a control module (e.g., control software) or a control system (e.g., a monitoring system of the article mapped by the digital twin) such that, for example, the digital twin can carry out control actions (e.g., the primary digital twin can insert transactions with updated data into the blockchain or independently check its data integrity on the basis of the blockchain).

In conjunction with embodiments of the invention, “device certification information” can be understood to mean, for example, an encoded data structure (e.g., text file, XML, JSON, ASN.1) that confirms information about the device in cryptographically secured fashion. The device certification information data structure is protected, for example, by a cryptographic checksum, in particular a digital signature or a message authentication code. In particular, the former is formed by the device by using a cryptographic key (e.g., for asymmetric or symmetric cryptographic methods). In particular, the device certification information data structure thus formed by the device can be formed only by the device itself and cannot be tampered with by third parties without detection. By way of example, a private key (e.g., in the case of an asymmetric cryptographic method) for creating the cryptographic checksum (e.g., the digital signature) is only known to the device. Specific examples of information of a device are, in particular, model (manufacturer, hardware revision), firmware version, loaded software modules (e.g., identifier, hash value, version number), current time of the clock of the device, status of the watchdog of the device (i.e., a monitoring apparatus of the device), configuration state, information about performed self-tests, information about the boot process or a combination of these information items.

The method is advantageous to the effect of, in particular, providing a trustworthy/security-protected digital twin by way of a decentralized blockchain infrastructure. This realizes a decentralized security-protected distribution of the data of the security-protected digital twin/of the selected portion of the data. In particular, the blockchain protects the security-protected digital twin from tampering and the latter can be made easily accessible. In particular, by contrast, further data, in particular with a high data volume and high change frequency, can be stored in a conventional digital twin (e.g., the primary digital twin). By way of example, if there is a change in a data record of the selected portion of the data in the primary digital twin, a new transaction can be inserted into the blockchain, for example, by means of the primary digital twin and a control module (e.g., control software), said new transaction comprising the modified data record in particular. In particular, this ensures consistency between the two digital twins (the primary digital twin and the security-protected digital twin). In particular, it is also conceivable that the selected portion of the data comprises the entire scope of the primary digital twin or only comprises parts of the primary digital twin. In particular, the security-protected digital twin can be provided in that case such that the latter can be transmitted to computers, in particular, or can be called by computers.

In a first embodiment of the method, the blocks are linked together by way of a cryptographic hash function.

In a further embodiment of the method, a datum of the selected data, a portion of the selected data or all selected data of the transactions are respectively updated by virtue of a further block with at least one further transaction being linked with correspondingly updated data with at least one of the other blocks of the blockchain or of the distributed database.

The method is advantageous to the effect of, in particular, ensuring the consistency between the two digital twins.

In a further embodiment of the method, a check of the integrity is controlled by the primary digital twin itself and/or controlled by system components and/or controlled by a physical object that is mapped by the primary digital twin.

The method is advantageous to the effect of, in particular, carrying out the consistency check from different places. In particular, these checks can be carried out at predetermined times, periodically, under manual control or by a service interval. In particular, system components can be understood to mean, in particular, network components such as gateways, firewalls or intrusion detection systems.

In a further embodiment of the method, a physical object, which is mapped by the primary digital twin, transfers device certification information to the primary digital twin. The primary digital twin inserts the device certification information as first further transaction of a first further block into the blockchain or into the distributed database and this first further block is linked to at least one of the other blocks of the blockchain or of the distributed database.

Embodiments of the invention is advantageous to the effect of, in particular, providing security-protected device certification information.

In a further embodiment of the method, the device certification information is protected by a second checksum, and a second further transaction of a second further block or the first further transaction comprises the first cryptographic checksum.

The method is advantageous to the effect of, in particular, additionally securing the device certification information with the second checksum (e.g., a digital signature) and facilitating identification of the node that is created by this information.

According to a further aspect, embodiments of the invention relates to an apparatus for computer-assisted creation of a security-protected digital twin, comprising:
a provision module for providing at least one selected portion of data of a primary digital twin;
a memory module for storing transactions, wherein
   the transactions comprise the selected portion of the data and/or
   first checksums are calculated for the selected portion of the data and the transactions comprise the first checksums;
a creation module for creating the security-protected digital twin by producing blocks of a blockchain or of a distributed database, wherein
   the blocks comprise the transactions,
   the blocks are linked together to form the blockchain or the distributed database.

In a further embodiment of the apparatus, the apparatus comprises a transfer module for transferring the security-protected digital twin.

The method is advantageous to the effect of, in particular transferring the security-protected digital twin to nodes or computers outside of the blockchain or querying the security-protected digital twin by the apparatus or node. By way of example, the transfer can be implemented in connection-oriented fashion (e.g., on a TCP/IP basis), without connection (e.g., on a UDP basis) or on a broadcast/multicast basis.

In a further embodiment of the apparatus, the apparatus comprises at least one further module or a plurality of further modules for carrying out the method according to embodiments of the invention (or one of its embodiments) for the computer-assisted creation of the security-protected digital twin.

Moreover, a computer program product (non-transitory computer readable storage medium having instructions, which when executed by a processor, perform actions) with program commands for carrying out the specified methods according to embodiments of the invention is claimed, wherein respectively one of the methods according to embodiments of the invention, all of the methods according to embodiments of the invention or a combination of the methods according to embodiments of the invention are performable by means of the computer program product.

Additionally, a variant of the computer program product with program commands for configuring a creation device, for example a 3D printer, a computer system or a production machine suitable for creating processors and/or devices is claimed, wherein the creation device is configured by means of the program commands in such a way that the specified apparatus according to embodiments of the invention is created.

Moreover, a provision apparatus is claimed for storing and/or providing the computer program product. By way of example, the provision apparatus is a data medium that stores and/or provides the computer program product. As an alternative and/or in addition thereto, the provision apparatus is, e.g., a network service, a computer system, a server system, in particular a distributed computer system, a cloud-based computer system and/or a virtual computer system, which stores and/or provides the computer program product, in the form of a data stream.

By way of example, this provision is implemented as a download in the form of a program data block and/or command data block, as a file, more particularly as a download file, or as a data stream, more particularly as a download data stream, of the complete computer program product. However, this provision can also be implemented, for example, as a partial download that consists of a plurality of parts and, in particular, is downloaded via a peer-to-peer network or provided as a data stream. By way of example, such a computer program product is read into a system using the provision apparatus in the form of the data medium and carries out the program commands such that the method according to embodiments of the invention is executed on a computer or the creation device is configured in such a way that it creates the apparatus according to embodiments of the invention.

### BRIEF DESCRIPTION

Some of the embodiments will be described in detail, with reference to the following figures, wherein like designations denote like members, wherein:

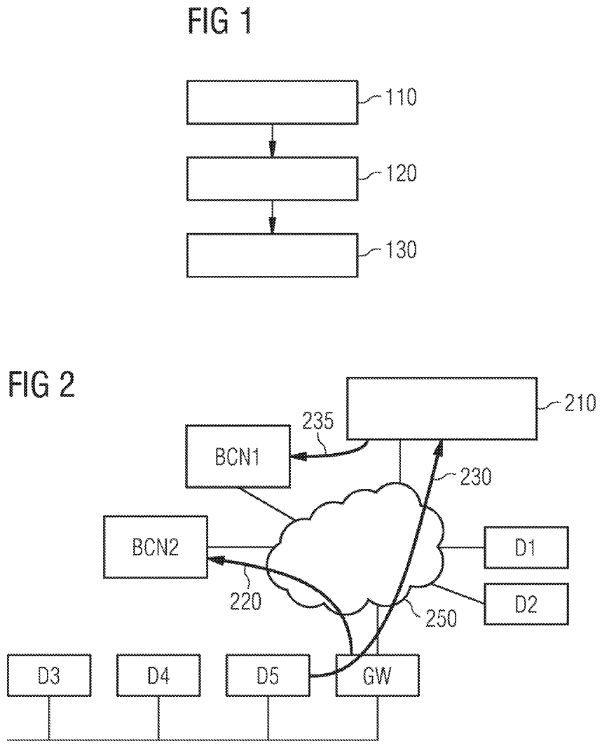

FIG. 1 shows a first exemplary embodiment of the invention as a flowchart;

FIG. 2 shows a second exemplary embodiment of the invention;

FIG. 3 shows a third exemplary embodiment of the invention;

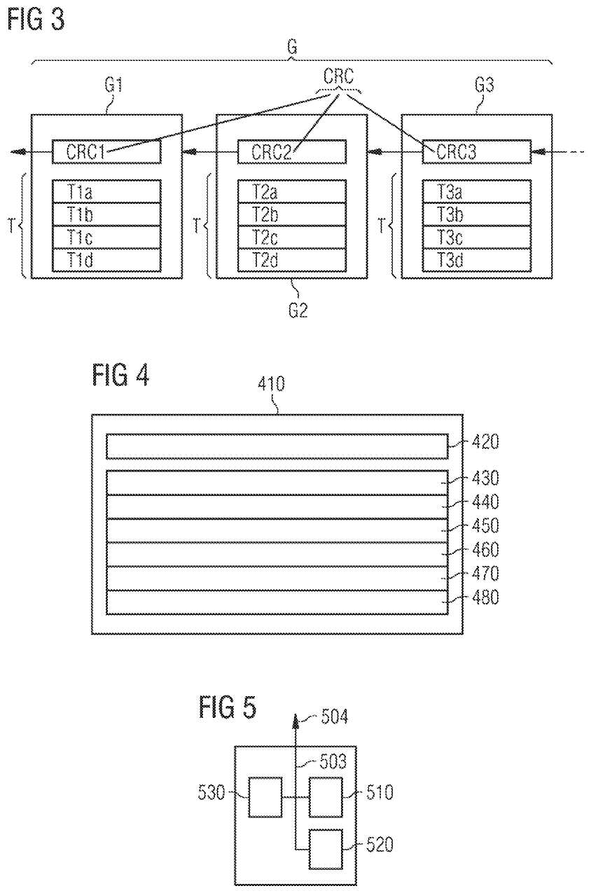

FIG. 4 shows a fourth exemplary embodiment of the invention; and

Provided nothing else is specified, functionally equivalent elements are provided with the same reference signs in the figures.

### DETAILED DESCRIPTION

Provided nothing else is specified or has already been specified, the following exemplary embodiments comprise at least one processor and/or a memory unit for implementing or executing the method.

Additionally, a (relevant) person skilled in the art, in particular, who is aware of the method claim/method claims, naturally also knows of all possibilities for realizing products or implementation possibilities that are conventional in the prior art such that, in particular, there is no need for a separate disclosure in the description. In particular, these conventional realization variants that are known to a person skilled in the art can be realized only by way of hardware (components) or only by way of software (components). As an alternative and/or in addition thereto, a person skilled in the art can, within their usual action in the art, choose largely arbitrary combinations according to embodiments of the invention of hardware (components) and software (components) in order to implement realization variants according to embodiments of the invention.

A combination according to the invention of hardware (components) and software (components) can occur, in particular, if some of the effects according to embodiments of the invention are only brought about by specialist hardware (e.g., a processor in the form of an ASIC or FPGA) and/or another part can be brought about by the (processor-assisted and/or memory-assisted) software.

In particular, in view of the great number of different realization options, it is neither possible nor productive or necessary for the understanding of embodiments of the invention to specify all these realization options. In this respect, all the subsequent exemplary embodiments, in particular, should only, by way of example, highlight a few ways of how, in particular, such realizations of the teaching according to embodiments of the invention could appear.

Consequently, the features of the individual exemplary embodiments, in particular, are not restricted to the specific exemplary embodiment but, in particular, relate to embodiments of the invention in general. Accordingly, features of one exemplary embodiment may also serve as features for another exemplary embodiment, in particular without this having to be explicitly mentioned in the respective exemplary embodiment.

FIG. 1 shows a first exemplary embodiment of the invention as a flowchart of the method according to embodiments of the invention for computer-assisted creation of a security-protected digital twin.

The method comprises a first method step of providing 110 at least one selected portion of data of a primary digital twin. Here it is possible, for example, to select security-critical data of the primary digital twin, the protection of the integrity of which being deemed to be important.

The method comprises a second method step of storing 120 transactions. Here, the transactions comprise the selected portion of the data, with this being realizable in different ways. It is conceivable for one of the transactions to comprise in each case one or more of the data records of the selected portion of the data—i.e., the latter are stored in the corresponding transaction. Alternatively, the transactions may comprise first checksums that are calculated for the data records of the selected portion of the data. In this variant, one of the transactions comprises one or more first checksums, which were each calculated for one of the data records of the selected portion of the data. In addition to the first checksums, the transactions may comprise, for example, a specification (e.g., an Internet address or a storage location on a data medium) in relation to from where a computer or a node can call the corresponding data (records) of the selected portion of the data. By way of example, it is also conceivable for this specification to be rendered known to computers and nodes in general (e.g., by way of a computer configuration or user profiles).

The method comprises a third method step of creating 130 the security-protected digital twin by producing blocks of a blockchain, wherein the blocks comprise the transactions and the blocks are linked together to form the blockchain.

As a result, an apparatus (e.g., a control module or a controller with a primary digital twin), for example, can insert the transactions with the security-protected digital twin into the blockchain or link the corresponding blocks with the transaction/transactions with at least one block of the blockchain.

Expressed differently, embodiments of the invention allows the provision of, in particular, information of a digital twin in security-protected fashion.

A conventional digital twin provides information about a physical object in digital form. These days, these data of such an object are found on specific servers, e.g., belonging to the manufacturer of a product or the operator of an installation. However, this is disadvantageous in that there is only restricted access to the data and that the stored data can be falsified.

Using the method according to embodiments of the invention, a digital twin is replicated, at least in part or only in part, in a blockchain. This is advantageous since this does not make the complete data of the primary digital twin available in the freely accessible blockchain. In particular, this would be neither practical (data volume) nor desirable (confidential, business-critical data).

Consequently, the security-protected digital twin comprises a subset of the information of the complete primary digital twin, in particular. However, this security-protected digital twin is freely accessible or at least accessible in relatively simple fashion for different users. The data or data records of the primary digital twin stored in the blockchain are, e.g., preprocessed (e.g., filtered, compressed, analyzed) in this case.

The data (records) of the security-protected digital twin can be updated by the primary digital twin, for example. To this end, the primary digital twin forms a transaction which, for example, comprises filtered and optionally preprocessed data of the physical object. In particular, the transactions are inserted into a blockchain or a block with a corresponding transaction is produced and linked with at least one block of the blockchain.

Consequently, a subset of the primary digital twin (or of its data record), for example, is provided in tamper-proof and freely or at least more freely accessible fashion by means of the blockchain.

By way of example, the primary digital twin can be realized by a project plan server or by a cloud-based IoT backend (Siemens Mindsphere, Microsoft Azure). In particular, the primary digital twin can continue to check its data for consistency using the data stored in tamper-proof fashion in the security-protected digital twin. As a result, tampering with, and inconsistencies of, the data of the primary digital twin can be identified and corrected where necessary.

However, it is also possible for this to be implemented on a gateway in one variant. A gateway, which transfers the data of the device to a primary digital twin of a backend, for example, can process or preprocess these data (records) and can form transactions as a function thereof, said transactions being used to produce the security-protected digital twin; that is to say, in particular, said gateway inserts or links these data (records) into the blockchain.

In a further variant, a physical object itself can update its data, stored in a blockchain, of its security-protected digital twin assigned thereto. This variant is advantageous in that it is usable and updatable independently of a conventional digital twin.

In a further variant, a plurality of sources (primary digital twin, gateway, device mapped by the primary digital twin) each insert transactions with data for the security-protected digital twin into the blockchain. This facilitates a better check of the consistency/integrity of the data, in particular.

In a further variant, a device provides device certification information, i.e., device information protected by a second (cryptographic) checksum, and transfers said device certification information to the primary digital twin. As a result, this information cannot be tampered with by the primary digital twin.

This device certification information can be provided to the security-protected digital twin as a portion of one of the transactions. In particular, it is only identified as valid within the blockchain if the certification is cryptographically valid (e.g., the digital signature has been successfully confirmed).

Examples of information or data (records) of a security-protected digital twin include:
current mode of operation of the device (operational, standby, failure, service, sealed/unseal ed)
current configuration, firmware status (identification information, e.g., a hash value or a configuration identifier)
servicing information, use information (usage data)
self-test data
battery status
estimated residual use duration
membership to the installation (system, group)

FIG. 2 shows a second exemplary embodiment of the invention, which is realized by a system.

In detail, FIG. 2 shows an exemplary system comprising a plurality of devices, for example a first device D1, a second device D2, a third device D3, a fourth device D4 and a fifth device D5. Additionally, a gateway GW, a control module (e.g., an Internet of Things backend/IoT backend) 210 for realizing a primary digital twin and a plurality of (blockchain) nodes (e.g., bitcoin nodes or Ethereum nodes), for example a first node BCN1 and a second node BCN2, are illustrated. The nodes, the devices, the gateway GW and the IoT backend 210 are connected to one another by way of a network 250 (e.g., LAN, WAN or the Internet).

By way of example, the fifth device D5 transmits device data 230, e.g., its monitoring data (device monitoring data) or current system data (e.g., information about operating temperature, power consumption), as a device status update message to its primary digital twin in the IoT backend 210 (e.g., via a CoAP, MQTT, Web Socket, XMPP protocol). The IoT backend 210 processes the information (update of the information of the primary digital twin, e.g., by filtering, processing).

The IoT backend 210 checks whether the device data belong to the selected portion of the data that should be provided by the security-protected digital twin by way of the blockchain. Should this be the case, the IoT backend 210 generates one or more transactions 235 as a function of the device data and provides said transactions to the nodes. These enter the transaction into the blockchain in the case of successful validation, for example by virtue of a block with these transactions being linked to a block of the blockchain. In this way, the nodes confirm the transaction in the blockchain, in particular.

FIG. 2 furthermore shows a variant in which the gateway GW forms one or more transactions 220 as a function of the device data of the fifth device D5 and provides said transactions to the second node BCN2, which inserts the transactions into the blockchain in an analogous fashion—as explained above.

In a further variant, the fifth device D5 itself, or one of the other devices (D1-D4), provides one or more transactions for the nodes as a function of the device data of the fifth device D5. The node inserts the transactions into the blockchain in an analogous fashion—as already explained above.

The gateway GW and the IoT backend 210 act as nodes of the blockchain. This means that they are involved in the formation or checking of the blockchain, together with further nodes.

By way of example, if the other devices are also nodes of the blockchain (e.g., the first device D1 and/or the second device D2) but have no access to the IoT backend 210 (e.g., they are not registered or have no authorization), these other devices can use/call at least the information of the fifth device D5 that is stored in the blockchain. Consequently, they are able to use, in particular, the information stored in the blockchain in tamper-proof fashion without having access to the primary digital twin. As a result, the data of the security-protected digital twin can be used, e.g., in flexible fashion by different stakeholders.

FIG. 3 shows a third exemplary embodiment of the invention, which represents a blockchain suitable for realizing the preceding exemplary embodiments.

In detail, FIG. 3 shows the blocks G, for example a first block G1, a second block G2 and a third block G3, of a blockchain.

The blocks G each comprise a plurality of transactions T. By way of example, the first block G1 comprises a first transaction T1a, a second transaction T1b, a third transaction T1c and a fourth transaction T1d. By way of example, the second block G2 comprises a fifth transaction T2a, a sixth transaction T2b, a seventh transaction T2c and an eighth transaction T2d. The third block G3 comprises a ninth transaction T3a, a tenth transaction T3b, an eleventh transaction T3c and a twelfth transaction T3d.

Additionally, the blocks G each still comprise a link checksum CRC, which is formed as a function of the directly preceding block. Consequently, the first block G1 comprises a first link checksum CRC1 from its preceding block, the second block G2 comprises a second link checksum CRC2 from the first block G1 and the third block G3 comprises a third link checksum CRC3 from the second block G2. The link checksum is formed by way of the block header of the corresponding preceding block. The link checksum CRC can be formed using a cryptographic hash function such as, e.g., SHA-256, KECCAK-256 or SHA-3.

Additionally, each of the blocks may comprise a transaction checksum. This can be realized by means of a hash tree.

In order to form the hash tree, a third/further checksum (e.g., likewise a hash value that is formed as a function of the transactions/transaction data records) is calculated for each transaction of a block. Usually, use is made of a hash tree, e.g., a Merkle tree or Patricia tree, whose root hash value/root checksum is stored in the respective block as a transaction checksum.

In one variant, the transaction checksum is used as a link checksum.

Furthermore, a block may comprise a timestamp, a digital signature, proof-of-work evidence, as explained in the embodiments of the invention.

FIG. 4 shows a fourth exemplary embodiment of the invention, in which one of the transactions of FIG. 3, e.g., the first transaction T1b, is explained in more detail.

In detail, FIG. 4 shows a transaction 410 with a plurality of data records. To be precise, a first data record 420, a second data record 430, a fourth data record 440, a fifth data record 450, a sixth data record 460 and a seventh data record 470.

The first data record 420 comprises identification data for the device to which the security-protected digital twin relates (MID: Siemens SiXY SN3175438). The second data record 430 comprises information about the hardware version (e.g., 3.12a). The third data record 440 comprises information about the firmware version (e.g., 17.12.6). The fourth data record 450 comprises an identifier or unique ID of the configuration of the device (e.g., Homag-XY41-V2a). The fifth data record 460 comprises a status indication of the battery of the device (e.g., battery 70% charged). The sixth data record 470 comprises information about the mode of operation of the device (e.g., service/maintenance mode, real-time mode, work mode). The seventh data record 480 comprises a timestamp that specifies, e.g., a capture time of the data (records) (e.g., 20161207-102237).

A transaction checksum (e.g., a hash value) is ascertained, as a function of the transaction, and inserted into a block of a blockchain, for example the blockchain of FIG. 3.

The transaction or the transaction checksum thereof is transferred to a node. When forming the next block, the transaction information (e.g., the transaction and/or the transaction checksum) is included in the next block.

As a result, the information about the transaction (i.e., corresponding data (records) of the selected portion of the data that are stored in the security-protected digital twin) is protected from tampering at later times on the basis of the block of the blockchain. The security-protected digital twin can be checked by third parties.

In particular, the data (records) of the transaction are ascertained as a function of the data of the primary digital twin of the device (as was already explained in the preceding exemplary embodiments).

This is implemented by a control module (e.g., the IoT backend of FIG. 2), i.e., by the primary digital twin itself (or by the computer system that realizes the primary digital twin or stores the data (records) of the primary digital twin).

However, it is also possible for this to be implemented on a gateway or on other system components, or on the device itself (e.g., the fifth device of FIG. 2).

FIG. 5 shows a fifth exemplary embodiment of the invention as an apparatus for computer-assisted provision of a security-protected digital twin. By way of example, the apparatus can be the IoT backend of FIG. 2.

The apparatus comprises a provision module 510, a memory module 520, a creation module 530 and an optional first communications interface 504 (e.g., for a link to the network of FIG. 2), which are connected to one another in communicative terms by way of a first bus 503.

By way of example, the apparatus still additionally comprises a further component or a plurality of further components, such as, e.g., a processor, a memory unit, an input device, more particularly a computer keyboard or a computer mouse, and a display device (e.g., a monitor). By way of example, the processor may comprise a plurality of further processors, wherein, for example, the further processors each realize one or more of the modules. Alternatively, the processor realizes all modules of the exemplary embodiment in particular. The further component(s) can likewise be connected to one another in communicative terms by way of the first bus 503, for example.

By way of example, the processor can be an ASIC, which has been realized in application-specific fashion for the functions of a respective module or of all modules of the exemplary embodiment (and/or of further exemplary embodiments), wherein the program component or the program commands, in particular, are realized as integrated circuits. By way of example, the processor may also be an FPGA which, in particular, is configured by means of the program commands in such a way that the FPGA realizes the functions of a respective module or of all modules of the exemplary embodiment (and/or of further exemplary embodiment).

The provision module 510 is configured to provide at least one selected portion of data of a primary digital twin.

By way of example, the provision module 510 can be implemented or realized by means of the processor, the memory unit and a first program component, wherein, for example, the processor is configured in such a way by executing program commands of the first program component or the processor is configured in such a way by the program commands that the selected portion of the data is provided.

The memory unit 520 is configured to store transactions, wherein
the transactions comprise the selected portion of the data and/or
first checksums are calculated for the selected portion of the data and the transactions comprise the first checksums.

By way of example, the memory module 520 can be implemented or realized by means of the processor, the memory unit and a second program component, wherein, for example, the processor is configured in such a way by executing program commands of the second program component or the processor is configured in such a way by the program commands that the transactions are stored.

The creation module 530 is configured to create the security-protected digital twin by producing blocks of a blockchain, wherein the blocks each comprise at least one of the transactions and the blocks are linked together to form the blockchain.

By way of example, the creation module 530 can be implemented or realized by means of the processor, the memory unit and a third program component, wherein, for example, the processor is configured in such a way by executing program commands of the third program component or the processor is configured in such a way by the program commands that the security-protected digital twin is created.

Here, the program commands of the respective modules can be executed by means of the processor itself and/or by means of an initialization component, for example a loader, or a configuration component.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for computer-assisted creation of a security-protected digital twin, including the following method steps:
providing at least one selected portion of data of a primary digital twin;
storing transactions, wherein
the transactions comprise the selected portion of the data and/or
first checksums are calculated for the selected portion of the data and the transactions comprise the first checksums;
creating the security-protected digital twin by producing blocks of a blockchain or of a distributed database, wherein
the blocks comprise the transactions,
the blocks are linked together to form the blockchain or the distributed database.

2. The method as claimed in claim 1, wherein the blocks are linked together by way of a cryptographic hash function.

3. The method as claimed in claim 1, wherein a datum of the selected data, a portion of the selected data or all selected data of the transactions are respectively updated by virtue of a further block with at least one further transaction being linked with correspondingly updated data with at least one of the other blocks of the blockchain or of the distributed database.

4. The method as claimed in claim 2, wherein an integrity of the primary digital twin is determined on a basis of the security-protected digital twin.

5. The method as claimed in claim 4, wherein a check of the integrity is controlled by the primary digital twin itself and/or controlled by system components and/or controlled by a physical object that is mapped by the primary digital twin.

6. The method as claimed in claim 1, wherein
a physical object, which is mapped by the primary digital twin, transfers device certification information to the primary digital twin,
the primary digital twin inserts the device certification information as first further transaction of a first further block into the blockchain or into the distributed database and this first further block is linked to at least one of the other blocks of the blockchain or of the distributed database.

7. The method as claimed in claim 6, wherein the device certification information is protected by a second checksum, and a second further transaction of a second further block or the first further transaction comprises the first cryptographic checksum.

8. An apparatus for computer-assisted creation of a security-protected digital twin, comprising:
a provision module for providing at least one selected portion of data of a primary digital twin;
a memory module for storing transactions, wherein
the transactions comprise the selected portion of the data and/or
first checksums are calculated for the selected portion of the data and the transactions comprise the first checksums;
a creation module for creating the security-protected digital twin by producing blocks of a blockchain or of a distributed database, wherein
the blocks comprise the transactions,
the blocks are linked together to form the blockchain or the distributed database.

9. The apparatus as claimed in claim 8, wherein the apparatus comprises a transfer module for transferring the security-protected digital twin.

10. A computer program product, comprising a computer readable hardware storage device having a computer readable program code stored therein, said program code executable by a processor of a computer system to implement a method, comprising program commands for carrying out the methods as claimed claim 1.

11. A computer program product, comprising a computer readable hardware storage device having a computer reliable program code stored therein, said program code executable by a processor of a computer system to implement a method comprising program commands for a creation device, which is configured by means of the program commands to create the apparatus as claimed in claim 8.

12. A provision apparatus for the computer program product as claimed in claim 10, wherein the provision apparatus stores and/or provides the computer program product.
